(19) United States
(12) Patent Application Publication
(10) Pub. No.: US 2007/0245951 A1
(43) Pub. Date: Oct. 25, 2007

(54) Nozzle for Coloring Electric Wire

(75) Inventors: Takeshi Kamata, Shizuoka (JP); Keigo Sugimura, Shizuoka (JP); Sei Saito, Shizuoka (JP); Kiyoshi Yagi, Shizuoka (JP)

Correspondence Address: KRATZ, QUINTOS & HANSON, LLP, 1420 K Street, N.W., Suite 400, WASHINGTON, DC, 20005, US

(73) Assignee: YAZAKI CORPORATION, Tokyo (JP)

(21) Appl. No.: 10/560,832

(22) PCT Filed: Jun. 7, 2004
(86) PCT No.: PCT/JP04/07945

§ 371 Date: Feb. 28, 2007

(30) Foreign Application Priority Data
Jun. 19, 2003 (JP) 2003-175258
Apr. 27, 2004 (JP) 2004-131474

(51) Int. Cl. B05C 5/00

(52) U.S. Cl. 118/300

(57) ABSTRACT

A nozzle for coloring an electric wire, by which the coloring agent can be securely spouted with a specific amount thereof per spouting toward a desired position on an outer surface of the electric wire, is provided. The nozzle 31 for coloring an electric wire spouts a liquid coloring agent with a specific amount thereof per spouting toward the outer surface of the wire so as to color the wire. The nozzle 31 includes cylindrical first and second nozzle members 37, 50 for allowing the coloring agent to flow therethrough in a direction of an arrow Q. The first and second nozzle members 37, 50 are connected coaxially to each other. The second nozzle member 50 is disposed nearer to the wire than the first nozzle member 37 is disposed. An inner diameter d of the second nozzle member 50 is smaller than an inner diameter D of the first nozzle member 37. An end surface 50a of the second nozzle member 50 near to the first nozzle member 37 protrudes toward the inside of the first nozzle member 37 from an inner surface of the first nozzle member 37. The end surface 50a is flat in a direction crossing at right angles the direction of the arrow Q.

### TECHNICAL FIELD

The present invention relates to a nozzle for coloring an electric wire, which includes an electrically conductive core wire and an electrically insulating coating that coats the core wire.

### BACKGROUND ART

Various electronic devices are mounted on a motor vehicle as a mobile unit. Therefore, the motor vehicle is provided with a wiring harness for transmitting power from a power source and control signals from a computer to the electronic devices. The wiring harness includes a plurality of electric wires and connectors attached to an end of the wires.

The wire includes an electrically conductive core wire and a coating made of insulating synthetic resin, which coats the core wire. The wire is a so-called coated wire. A connector includes a terminal fitting and a connector housing that receives the terminal fitting therein. The terminal fitting, consisting of electrically conductive sheet metal or the like, is attached to an end of the wire and electrically connected to the core wire of the wire. The connector housing made of electrically insulating synthetic resin is formed in a box-shape. When the connector housing is connected to the electronic devices, each wires is connected to the corresponding electronic device through the terminal fitting, thereby the wiring harness transmits the desired electric power and signals to the electronic devices.

When the wiring harness is assembled, first the wire is cut into a specific length and then the terminal fitting is attached to an end of the wire after removing the coating near the end. A wire is connected to another wire according to the need. Afterward, the terminal fitting is inserted into the connector housing, thereby assembling the wiring harness.

The wire of the wiring harness must be distinguished in terms of the size of the core wire, the material of the coating (concerning with alteration in the materials depending upon heat-resisting property), and a purpose of use. The purpose of use means, for example, an air bag, antilock brake system (ABS), control signal such as speed data, and system in a motor vehicle in which the wire is used, such as a power transmission system.

The coating of the wire used in the wiring harness has been colored to a desired color by mixing a coloring agent of the desired color with synthetic resin which constitutes the coating when the synthetic resin of the coating is applied onto the circumference of the core wire by extrusion (for example, see Patent Publications 1-3). In this case, when a color of an outer surface of the wire is altered, it is necessary to halt an operation of an extrusion apparatus that performs the extrusion-coating. That is, whenever the color of the wire is changed, it is necessary to halt an operation of an extrusion apparatus, causing increasing in a time period and labor hour required for the production of the wire and deteriorating in the productivity of the wire.

Alternatively, the coloring agent to be mixed has been replaced while the extrusion apparatus is performing the extrusion-coating. In such a case, right after changing the color of the coloring agent, a wire, in the color of the synthetic resin of which a coloring agent before the replacement and a coloring agent after the replacement are mixed, has been inevitably manufactured, causing the deterioration in the yield of the material of the wire.

In order to prevent the deterioration in the productivity of the wire and in the yield of the material of the wire, the present applicant proposed a method, in which monochromatic wire is produced, then the outer surface of the wire is colored with a desired color according to the need, thereby assembling a wiring harness (see Patent Publication 4). Alternatively, the present applicant proposed an apparatus for coloring a wire, by which upon coloring a monochromatic wire, a liquid coloring agent is spouted toward the outer surface of the wire with a specific amount thereof per spouting so as to allow the liquid drop of the coloring agent to adhere to the outer surface of the wire, thereby coloring the wire with the desired color (see Patent Publication 5).

[Patent Publication 1] Japanese Patent Application Laid-Open No. H5-111947

[Patent Publication 2] Japanese Patent Application Laid-Open No. H6-119833

[Patent Publication 3] Japanese Patent Application Laid-Open No. H9-92056

[Patent Publication 4] Japanese Patent Application No. 2001-256721

[Patent Publication 5] Japanese Patent Application No. 2002-233729

### DISCLOSURE OF THE INVENTION

### Problems that the Invention is to Solve

The coloring agent that is spouted toward the outer surface of the wire with a specific amount thereof per spouting is a liquid substance, in which a coloring material (organic substance for use in industry) is dissolved and dispersed in water or other solvent. The organic substance described above is a dye or a pigment (most of them being organic substances and synthetic substances). Sometimes, a dye is used as a pigment and a pigment is used as a dye.

Therefore, in the proposed apparatus for coloring an electric wire as described above, when the spouting of the coloring agent is repeatedly carried out from a coloring nozzle, the dye or pigment adheres to the nozzle, then the amount of thus adhered dye or pigment gradually increases. If the coloring agent adheres to the coloring nozzle, it becomes difficult to spout the coloring agent in a desired direction from the coloring nozzle and to spout the coloring agent with a specific amount thereof per spouting.

In such a troublesome case, of course it becomes difficult to color the desired position of the wire and to form a colored zone having a uniform area. Thus, a dye or pigment adheres to the nozzle, so that it becomes difficult to securely spout the coloring agent with a specific amount thereof per spouting toward the desired position on the outer surface of the wire.

It is therefore an objective of the present invention to solve the above problem and to provide a nozzle for coloring an electric wire, by which the coloring agent can be securely spouted with a specific amount thereof per spouting toward a desired position on an outer surface of the electric wire.

### MEANS OF SOLVING THE PROBLEMS

In order to solve the above problem and to attain the above objective, a nozzle for coloring an electric wire of the present invention described in claim 1 is a nozzle for coloring an electric wire, which spouts a liquid coloring agent with a specific amount thereof per spouting toward an outer surface of the electric wire so that a liquid drop of the coloring agent adheres to the outer surface of the electric wire, the nozzle including:

a receiver for receiving the coloring agent therein;

a first nozzle part formed in a cylindrical shape for allowing the coloring agent to pass therethrough (that is, to pass therein), the first nozzle part communicating with the receiver; and

a second nozzle part formed in a cylindrical shape having an inner diameter smaller than that of the first nozzle part for allowing the coloring agent to pass therethrough (that is, to pass therein), the second nozzle part being connected to the first nozzle part,

wherein the second nozzle part is disposed nearer to the electric wire than the first nozzle part is disposed,

wherein between the first and second nozzle parts there is formed a step protruding from an inner surface of the first nozzle part toward the inside of the first nozzle part.

A nozzle for coloring an electric wire of the present invention described in claim 2 is characterized in that, regarding the nozzle for coloring an electric wire described in claim 1, the step is formed flat in a direction crossing at right angles a direction in which the coloring agent flows in the first and second nozzle parts.

A nozzle for coloring an electric wire of the present invention described in claim 3 is characterized in that, regarding the nozzle for coloring an electric wire described in claim 1, the step is formed flat in a direction crossing both a direction in which the coloring agent flows in the first and second nozzle parts and a direction crossing at right angles the direction in which the coloring agent flows.

A nozzle for coloring an electric wire of the present invention described in claim 4 is characterized in that, regarding the nozzle for coloring an electric wire described in claim 3, the step is formed on at least one of the first and second nozzle parts.

A nozzle for coloring an electric wire of the present invention described in claim 5 is characterized in that, regarding the nozzle for coloring an electric wire described in any one of claims 1-4, the first and second nozzle parts are connected coaxially to each other. That is, the first nozzle part is connected to and aligned with the second nozzle part.

A nozzle for coloring an electric wire of the present invention described in claim 6 is characterized in that, regarding the nozzle for coloring an electric wire described in any one of claims 1-5, the nozzle satisfies a condition of 8≦L/l≦10, wherein L is the sum of a length of the first nozzle part and a length of the second nozzle part in a direction in which the coloring agent flows, and l is the length of the second nozzle part in the direction in which the coloring agent flows.

A nozzle for coloring an electric wire of the present invention described in claim 7 is characterized in that, regarding the nozzle for coloring an electric wire described in any one of claims 1-5, the nozzle satisfies a condition of 4≦D/d≦6, wherein D is an inner diameter of the first nozzle part, and d is an inner diameter of the second nozzle part.

A nozzle for coloring an electric wire of the present invention described in claim 8 is characterized in that, regarding the nozzle for coloring an electric wire described in any one of claims 1-5, the nozzle satisfies a condition of 8≦L/l≦10, wherein L is the sum of a length of the first nozzle part and a length of the second nozzle part in a direction in which the coloring agent flows, and l is the length of the second nozzle part in the direction in which the coloring agent flows, and also satisfies a condition of 4≦D/d≦6, wherein D is an inner diameter of the first nozzle part, and d is an inner diameter of the second nozzle part.

A nozzle for coloring an electric wire of the present invention described in claim 9 is characterized in that, regarding the nozzle for coloring an electric wire described in any one of claims 1-8, the second nozzle part is made of polyetheretherketone.

A nozzle for coloring an electric wire of the present invention described in claim 10 is a nozzle for coloring an electric wire, which spouts a liquid coloring agent with a specific amount thereof per spouting toward an outer surface of the electric wire so that a liquid drop of the coloring agent adheres to the outer surface of the electric wire, the nozzle including:

a receiver for receiving the coloring agent therein;

a first nozzle part formed in a cylindrical shape for allowing the coloring agent to pass therethrough (that is, to pass therein), the first nozzle part communicating with the receiver; and

a second nozzle part formed in a cylindrical shape for allowing the coloring agent to pass therethrough (that is, to pass therein), the second nozzle part being connected to the first nozzle part,

wherein the second nozzle part is disposed nearer to the electric wire than the first nozzle part is disposed,

wherein the second nozzle part is made of polyetheretherketone.

According to the present invention described in claim 1, a part of the coloring agent spouted toward the outer surface of the wire through the first and second nozzle parts collides against the step that protrudes toward the inside of the first nozzle part. Then, the coloring agent that has collided against the step causes occurrence of a vortex between the first and second nozzle parts. The coloring agent is stirred by the vortex thus occurred.

Since the inner diameter of the second nozzle part is smaller than that of the first nozzle part, when the coloring agent enters into the second nozzle part from the first nozzle part, the coloring agent is rapidly pressurized.

In this specification, the coloring agent means a liquid substance, in which a coloring material (organic substance for use in industry) is dissolved and dispersed in water or other solvent. The organic substance described above is a dye or a pigment (most of them being organic substances and synthetic substances). Sometimes, a dye is used as a pigment and a pigment is used as a dye. As an example, the coloring agent may be a coloring liquid or coating material. The coloring liquid is a liquid, in which a dye is dissolved or dispersed in a solvent. The coating material is a material, in which a pigment is dispersed in a liquid dispersion. When the outer surface of the coating is colored with a coloring liquid, the dye permeates into the coating. When the outer surface of the coating is colored with a coating material, the pigment adheres to the outer surface without permeating into the coating. In the specification, “to color the outer surface of the electric wire” means to dye a part of the outer surface of the coating of the wire with a dye or to coat a part of the outer surface of the coating of the wire with a pigment.

Preferably, the solvent and liquid dispersion have an affinity to the synthetic resin that constitutes the coating in order to securely permeate the dye into the coating or to allow the pigment to securely adhere to the outer surface of the coating.

In this specification, “spouting” means that the liquid coloring agent in a state of a liquid drop (or liquid drops) is ejected vigorously from the coloring nozzle (that is, the nozzle for coloring the electric wire) toward the outer surface of the wire.

According to the present invention described in claim 2, the step is flat in a direction crossing at right angles a direction in which the coloring agent flows. Therefore, when the coloring agent collides against the step, it causes occurrence of a vortex in the coloring agent and the coloring agent is stirred by the vortex thus occurred.

According to the present invention described in claim 3, the step is formed flat in a direction crossing both a direction in which the coloring agent flows in the first and second nozzle parts and a direction crossing at right angles the direction in which the coloring agent flows. Therefore, the inner diameter of the nozzle part is gradually decreased because of the step as advancing to an end of the nozzle part. Thereby, the coloring agent that flows through the nozzle part (i.e. flows in the nozzle part) is not rapidly pressurized but gradually pressurized.

According to the present invention described in claim 4, the step is formed on at least one of the first and second nozzle parts. Therefore, the coloring agent that flows through the nozzle part is not rapidly pressurized but gradually pressurized securely.

According to the present invention described in claim 5, the first and second nozzle parts are connected coaxially to each other. Therefore, when the coloring agent collides against the step, the vortex occurs uniformly over the whole circumference of the first nozzle part, thereby the coloring agent is stirred.

According to the present invention described in claim 6, the nozzle satisfies such a condition that L/l is equal to or larger than 8 and equal to or smaller than 10, wherein L is the sum of a length of the first nozzle part and a length of the second nozzle part in a direction in which the coloring agent flows, and l is the length of the second nozzle part in the direction in which the coloring agent flows. Therefore, when the coloring agent enters into the second nozzle part from the first nozzle part, the coloring agent is pressurized so as to maintain its form of a liquid drop (or liquid drops) upon spouting and to be spouted in a desired direction.

According to the present invention described in claim 7, the nozzle satisfies such a condition that D/d is equal to or larger than 4 and equal to or smaller than 6, wherein D is an inner diameter of the first nozzle part, and d is an inner diameter of the second nozzle part. Therefore, when the coloring agent enters into the second nozzle part from the first nozzle part, the coloring agent is pressurized so as to maintain its form of a liquid drop (or liquid drops) upon spouting and to be spouted in a desired direction.

According to the present invention described in claim 8, the nozzle satisfies such a condition that L/l is equal to or larger than 8 and equal to or smaller than 10, wherein L is the sum of a length of the first nozzle part and a length of the second nozzle part in a direction in which the coloring agent flows, and l is the length of the second nozzle part in the direction in which the coloring agent flows, and also satisfies such a condition that D/d is equal to or larger than 4 and equal to or smaller than 6, wherein D is an inner diameter of the first nozzle part, and d is an inner diameter of the second nozzle part. Therefore, when the coloring agent enters into the second nozzle part from the first nozzle part, the coloring agent is pressurized so as to maintain its form of a liquid drop (or liquid drops) upon spouting and to be spouted in a desired direction.

According to the present invention described in claim 9, the second nozzle part is made of polyetheretherketone. Therefore, the coloring agent hardly adheres to the second nozzle part.

According to the present invention described in claim 10, the second nozzle part is made of polyetheretherketone. Therefore, the coloring agent hardly adheres to the second nozzle part.

### INDUSTRIAL APPLICABILITY

As explained above, according to the present invention described in claim 1, the coloring agent collides against the step so that the coloring agent is stirred. Therefore, the concentration of a dye or pigment in the coloring agent is maintained uniform, thereby it can be avoided that an abnormally concentrated coloring agent adheres to the coloring nozzle.

When the coloring agent enters into the second nozzle part from the first nozzle part, the coloring agent is rapidly pressurized. Therefore, the coloring agent is vigorously spouted from the second nozzle part toward the outer surface of the wire, thereby preventing the coloring agent from adhering to the second nozzle part.

Since the coloring agent is prevented from adhering to the second nozzle part, the coloring agent with a specific amount thereof per spouting can be spouted securely from the second nozzle part toward the outer surface of the wire. Further, since the coloring agent is prevented from adhering to the second nozzle part, it can be prevented that the coloring agent that has adhered to the second nozzle part influences a direction in which the coloring agent is spouted. Therefore, the coloring agent with a specific amount thereof per spouting can be spouted securely toward a desired position on the outer surface of the wire. The desired position on the outer surface of the wire can be colored with a desired color. The colored position can be maintained to have a desired area (i.e. size).

According to the present invention described in claim 2, since the step is flat in a direction crossing at right angles a direction in which the coloring agent flows, the coloring agent is securely stirred. Therefore, the coloring agent is prevented from adhering to the second nozzle part and the coloring agent with a specific amount thereof per spouting can be spouted securely toward a desired position on the outer surface of the wire. Therefore, the desired position on the outer surface of the wire can be colored with a desired color and the colored position can be maintained to have a desired area (i.e. size).

According to the present invention described in claim 3, since the coloring agent that flows through the nozzle part is not rapidly pressurized but gradually pressurized, the coloring agent can be pressurized without forming an air bubble in the nozzle part and can be accelerated. Therefore, the coloring agent to be spouted from the nozzle part toward the outer surface of the wire is securely spouted in a form of a liquid drop. Therefore, the coloring agent can securely adhere to the desired position on the wire without scattering to an undesired position. That is, the desired position of the outer surface of the wire can be securely colored.

According to the present invention described in claim 4, since the coloring agent that flows through the nozzle part is not rapidly pressurized but gradually pressurized, the coloring agent can be pressurized without forming an air bubble in the nozzle part and can be accelerated. Therefore, the coloring agent to be spouted from the nozzle part toward the outer surface of the wire is securely spouted in a form of a liquid drop (or liquid drops). Therefore, the coloring agent can securely adhere to the desired position on the wire without scattering to an undesired position. That is, the desired position of the outer surface of the wire can be securely colored.

According to the present invention described in claim 5, the first and second nozzle parts are connected coaxially to each other. Therefore, the coloring agent is securely stirred uniformly. Therefore, the coloring agent is prevented from adhering to the second nozzle part and the coloring agent with a specific amount thereof per spouting can be spouted securely toward a desired position on the outer surface of the wire. Therefore, the desired position on the outer surface of the wire can be colored with a desired color and the colored position can be maintained to have a desired area (i.e. size).

According to the present invention described in claim 6, upon spouting, the coloring agent is pressurized so as to maintain a form of a liquid drop and so as to be spouted toward the desire position. That is, the coloring agent in a form of a liquid drop is securely spouted toward the desired position on the outer surface of the wire with a specific amount thereof per spouting. The desired position on the outer surface of the wire can be colored with a desired color and the colored position can be maintained to have a desired area (i.e. size).

According to the present invention described in claim 7, upon spouting, the coloring agent is pressurized so as to maintain a form of a liquid drop and so as to be spouted toward the desire position. That is, the coloring agent in a form of a liquid drop is securely spouted toward the desired position on the outer surface of the wire with a specific amount thereof per spouting. The desired position on the outer surface of the wire can be colored with a desired color and the colored position can be maintained to have a desired area (i.e. size).

According to the present invention described in claim 8, upon spouting, the coloring agent is pressurized so as to maintain a form of a liquid drop and so as to be spouted toward the desire position. That is, the coloring agent in a form of a liquid drop is securely spouted toward the desired position on the outer surface of the wire with a specific amount thereof per spouting. The desired position on the outer surface of the wire can be colored with a desired color and the colored position can be maintained to have a desired area (i.e. size).

According to the present invention described in claim 9, the second nozzle part is made of polyetheretherketone, so that the coloring agent hardly adheres to the second nozzle part. Therefore, it can be prevented that the coloring agent that has adhered to the second nozzle part influences a direction in which the coloring agent is spouted. Therefore, the coloring agent with a specific amount thereof per spouting can be spouted securely toward a desired position on the outer surface of the wire. The desired position on the outer surface of the wire can be colored with a desired color. The colored position can be maintained to have a desired area (i.e. size).

According to the present invention described in claim 10, the second nozzle part is made of polyetheretherketone, so that the coloring agent hardly adheres to the second nozzle part. Therefore, it can be prevented that the coloring agent that has adhered to the second nozzle part influences a direction in which the coloring agent is spouted. Therefore, the coloring agent with a specific amount thereof per spouting can be spouted securely toward a desired position on the outer surface of the wire. The desired position on the outer surface of the wire can be colored with a desired color. The colored position can be maintained to have a desired area (i.e. size).

### BEST MODE FOR CARRYING OUT THE INVENTION

In the following, a nozzle for coloring an electric wire (hereinafter, a coloring nozzle) according to preferred embodiments of the present invention will be explained with reference to FIGS. 1-8. A coloring nozzle 31 shown in FIG. 4 and so on constitutes an apparatus 1 for coloring an electric wire (hereinafter, a coloring apparatus 1) shown in FIG. 1 and so on. The coloring apparatus 1 cuts an electric wire 3 into a specific length and forms a mark 6 on a part of an outer surface 3a of the electric wire 3. That is, the coloring apparatus 1 colors the outer surface 3a of the wire 3, that is, the coloring apparatus 1 carries out the marking on the outer surface 3a of the wire 3.

An electric wire 3 constitutes a wiring harness to be mounted on a motor vehicle or the like as a mobile unit. As shown in FIG. 6A and so on, the wire 3 includes an electrically conductive core wire 4 and an electrically insulating coating 5. A plurality of element wires are bundled up to form the core wire 4. Each element wire of the core wire 4 is made of electrically conductive metal. The core wire 4 may be constituted by a single element wire. The coating 5 is made of synthetic resin such as polyvinyl chloride (PVC). The coating 5 coats the core wire 4. Therefore, the outer surface 3a of the wire 3 means an outer surface of the coating 5.

The coating 5 has a monochrome color P, for example a white color. A desired coloring agent may be mixed with the synthetic resin of the coating 5 so as to make the color of the outer surface 3a of the wire 3 be a monochrome color P, or alternatively, the monochrome color P may be set as the color of the synthetic resin itself without adding a coloring agent to the synthetic resin of the coating 5. In the latter case, the outer surface 3a of the wire 3 is not colored, i.e. the coating 5 is not colored.

On the outer surface 3a of the wire 3, there are formed a mark 6 consisting of a plurality of spots 7. The spot 7 has a color B (indicated with parallel oblique lines in FIGS. 6A and 6B), which is different from the monochrome color P. The spot 7 is round in the plan view as shown in FIG. 6B. A plurality of the spots 7 are arranged in the longitudinal direction of the wire 3 according to a predetermined pattern. In FIG. 6B as an example, the spots 7 are arranged having the same distance therebetween in the longitudinal direction of the wire 3. The distance between the centers of the spots 7 situated adjacently to each other is predetermined.

A plurality of the wires 3 are bundled and connectors are attached to respective ends of the wires 3, thereby constructing a wiring harness. The connectors are coupled with respective mating connectors of various electronic instruments in a motor vehicle and so on, thereby the wiring harness (i.e. the wires 3) transmits various signals and electric power to the electronic instruments.

The wires 3 are distinguishable from one another by changing a color B of each spot 7 of the mark 6. In the figure, as an example, the color B of all of the spots 7 is set the same, however, the color B may be changed for the respective spots 7 according to the need. The color B is used to distinguish types of the wires in a wiring harness or systems. That is, the color B is used to distinguish the types of the wires 3 in the wiring harness or the purposes of use.

As shown in FIG. 1, the coloring apparatus 1 includes a frame 10 as a body of the apparatus, guide roll 11, delivery roll 12 (i.e. forwarding roll) as transfer means, correction unit 13 as wire correction means, slack absorbing unit 14 as slack absorbing means, coloring unit 15, duct 16, encoder 17 as measuring means, cutting mechanism 18 as machining means, and control device 19 as control means.

The frame 10 is placed on a floor in a plant. The frame 10 extends in a horizontal direction. The guide roll 11 is rotatably attached to an end of the frame 10. The guide roll 11 winds up a long wire 3, on which a mark 6 is not formed. The guide roll 11 forwards the wire 3 by way of the correction unit 13, slack absorbing unit 14, coloring unit 15, duct 16, encoder 17 and cutting mechanism 18 in sequence.

A pair of the delivery rolls 12 is placed at an opposite end of the frame 10. The pair of the delivery rolls 12 is rotatably supported by the frame 10 and arranged in a vertical direction. The delivery rolls 12 are rotated by a motor (not shown in the figure) with the same number of revolutions in respective directions, which are reverse to each other. The delivery rolls 12 put the wire 3 therebetween and pull the wire 3 in the longitudinal direction of the wire 3 from the guide roll 11.

The delivery rolls 12 is pulling means, which pulls and transfers the wire 3 in the longitudinal direction of the wire 3. Thus, the delivery rolls 12 transfers the wire 3 in the longitudinal direction of the wire 3, so that the delivery rolls 12 moves a coloring nozzle 31 (explained later on) of the coloring unit 15 and the wire 3 relatively to each other in the longitudinal direction of the wire 3. That is, the wire 3 is transferred from the guide roll 11 toward the delivery roll 12 in a direction of an arrow K shown in FIG. 1. That is, the arrow K shows a transferring direction of the wire 3.

The correction unit 13 is placed on the delivery roll 12-side of the guide roll 11. That is, the correction unit 13 is placed between the guide roll 11 and the delivery roll 12. That is, the correction unit 13 is placed on the downstream side of the guide roll 11 in the transferring direction K of the wire 3. That is, the correction unit 13 is placed on the upstream side of the delivery roll 12 in the transferring direction K of the wire 3. The correction unit 13 includes a plate-shaped unit body 20, a plurality of first rollers 21 and a plurality of second rollers 22. The unit body 20 is fixed on the frame 10.

A plurality of the respective first and second rollers 21, 22 are rotatably supported by the unit body 20. A plurality of the first rollers 21 are arranged in a horizontal direction (in the transferring direction K) above the wire 3. A plurality of the second rollers 22 are arranged in a horizontal direction (in the transferring direction K) below the wire 3. As shown in FIG. 1, the first and second rollers 21 and 22 are arranged zigzag.

The correction unit 13 puts the wire 3, which is forwarded by the delivery roll 12 from the guide roll 11, between the first rollers 21 and the second rollers 22, thereby making the wire 3 straight. By putting the wire 3 between the first rollers 21 and the second rollers 22, the correction unit 13 gives friction force to the wire 3. That is, the correction unit 13 gives first bias force H1 having a direction reverse to the direction, in which the delivery roll 12 pulls the wire 3 (i.e. the transferring direction K), to the wire 3. The first bias force H1 is smaller than the force that the delivery roll 12 pulls the wire 3. Therefore, the correction unit 13 gives the tension having a direction, which is along the longitudinal direction of the wire 3, to the wire 3.

The slack absorbing unit 14 is placed on the delivery roll 12-side of the correction unit 13. That is, the slack absorbing unit 14 is placed between the correction unit 13 and the delivery roll 12. That is, the slack absorbing unit 14 is placed on the downstream side of the correction unit 13 in the transferring direction K of the wire 3. The slack absorbing unit 14 is placed on the upstream side of the delivery roll 12 in the transferring direction K of the wire 3. The slack absorbing unit 14 is placed between the correction unit 13 and a coloring nozzle 31 (explained later on) of the coloring unit 15.

As shown in FIG. 1, the slack absorbing unit 14 includes a pair of guide rollers 24, a pair of guide roller supporting frames 23, transfer roller 26, transfer roller supporting frame 25, and air cylinder 27 as bias means (i.e. energizing means). The pair of the guide roller supporting frames 23 is fixed on the frame 10. The pair of the guide roller supporting frames 23 stands up from the frame 10. The guide roller supporting frames 23 are arranged having a distance therebetween in the transferring direction K of the wire 3.

The pair of the guide rollers 24 is rotatably supported by the pair of the guide roller supporting frames 23. The guide roller 24 is arranged below the wire 3 and comes in contact with the wire 3 on the outer circumferential surface thereof so as to guide the wire 3 in the transferring direction K of the wire 3 preventing the wire 3 from coming off from the transferring direction K.

The transfer roller supporting frame 25 is fixed on the frame 10. The transfer roller supporting frame 25 stands up from the frame 10. The transfer roller supporting frame 25 is placed between the pair of the guide roller supporting frames 23.

The transfer roller 26 is rotatably supported by the transfer roller supporting frame 25 movably in the vertical direction. The transfer roller 26 is arranged above the wire 3. The transfer roller 26 is supported movably in the vertical direction, that is, the transfer roller 26 is supported movably in a direction crossing at right angles the transferring direction K of the wire 3. The transfer roller 26 is placed in the middle of the pair of the guide rollers 24.

The air cylinder 27 includes a cylinder body 28 and stretchable rod 29 stretchable from the cylinder body 28. The cylinder body 28 is fixed to the transfer roller supporting frame 25 and arranged above the wire 3. The stretchable rod 29 extends downward from the cylinder body 28. That is, the stretchable rod 29 extends from the cylinder body 28 in a direction in which the stretchable rod 29 approaches toward the wire 3.

The transfer roller 26 is attached to the stretchable rod 29. By receiving pressurized gas in the cylinder body 28, the air cylinder 27 energizes the stretchable rod 29 (or the transfer roller 26) downward in a direction crossing at right angles the transferring direction K of the wire 3 with a second bias force H2 (shown in FIG. 1). That is, the air cylinder 27 energizes the transfer roller 26 in a direction in which the transfer roller 26 approaches toward the wire 3 with the second bias force H2. The second bias force H2 is smaller than the first bias force H1.

Since cutting blades 48 and 49 of a pair of the cutting blades 48, 49 (explained later on) in the cutting mechanism 18 approach each other so as to cut the wire 3, if the wire 3 advances in the transferring direction K with inertia when the wire 3 is stopped to be cut, the wire 3 slackens between the pair of the guide rollers 24. At this time, in the slack absorbing unit 14, since the air cylinder 27 energizes the transfer roller 26 with the second bias force H2, the stretchable rod 29 of the air cylinder 27 extends, so that the transfer roller 26 is displaced to, for example, a position, which is indicated by an alternate long and two short dashes line in FIG. 1. Then, the slack absorbing unit 14 energizes the wire 3, which slackens between the pair of the guide rollers 24, in the direction crossing at right angles the transferring direction K of the wire 3 so as to absorb the slack, thereby keeping the wire 3 stretched.

The coloring unit 15 is placed on the delivery roll 12-side of the slack absorbing unit 14. That is, the coloring unit 15 is placed between the slack absorbing unit 14 and the delivery roll 12. That is, the coloring unit 15 is placed on the downstream side of the slack absorbing unit 14 in the transferring direction K of the wire 3. The coloring unit 15 is placed on the upstream side of the delivery roll 12 in the transferring direction K of the wire 3. That is, the coloring unit 15 (i.e. the coloring nozzle 31 explained later on) is placed between the delivery roll 12 and the correction unit 13.

As shown in FIG. 2, the coloring unit 15 includes a unit body 30, a plurality of coloring nozzles 31, a plurality of coloring agent supply source 32 (only one source 32 being drawn in the figure and other sources 32 being omitted to be drawn) and pressurized gas supply source 33. The unit body 30 is fixed on the frame 10. The unit body 30 supports a plurality of the coloring nozzles 31.

The coloring nozzle 31 spouts a coloring agent supplied from the coloring agent supply source 32 toward the outer surface 3a of the wire 3 with a specific amount of the coloring agent per spouting. The coloring nozzle 31 allows spouted liquid drop (or drops) of the coloring agent to adhere to the outer surface 3a of the wire 3 so as to color (i.e. mark) at least a part of the outer surface 3a of the wire 3. A detailed structure of the coloring nozzle 31 will be explained later on.

When a plurality of the coloring nozzles 31 are attached to the unit body 30, the coloring nozzles 31 are arranged in the transferring direction K of the wire 3 and also arranged in a circumferential direction around the wire 3. In FIG. 1 as an example, five coloring nozzles 31 are arranged in the transferring direction K of the wire 3 in the unit body 30. In FIG. 2 as an example, three coloring nozzles 31 are arranged in the circumferential direction around the wire 3.

As shown in FIG. 3, the coloring nozzles 31 are supported by the unit body 30 in a state that the uppermost part 3b of the wire 3 is positioned on an extending line of the center axes R (shown by an alternate long and short dash line in FIG. 3) of the first nozzle member 37 (explained later on). The coloring nozzles 31 spout the coloring agent along the respective center axes R. That is, each coloring nozzle 31 spouts the coloring agent toward the uppermost part 3b of the wire 3 with a specific amount thereof per spouting. The coloring nozzle 31 is coloring means.

The coloring agent supply source 32 receives the coloring agent and supplies the coloring agent into an inlet pipe 36 of the coloring nozzle 31. The coloring agent supply sources 32 corresponds to the respective mating coloring nozzles 31. The colors B of the coloring agents supplied from the coloring agent supply sources 32 to the coloring nozzles 31 may be different from each other or, alternatively, the same with each other.

The pressurized gas supply source 33 supplies pressurized gas into the coloring agent supply sources 32. After the pressurized gas is supplied into the coloring agent supply sources 32, when a valve element 44 of the coloring nozzle 31 leaves a base end 37a of the first nozzle member 37 (i.e. the first nozzle part), the coloring agent situated in a channel 39 is spouted rapidly from the first nozzle member 37 and the second nozzle member 50 (i.e. the second nozzle part).

In the coloring nozzle 31, on the basis of a command from the control device 19, a current flows into a coil 40 of the coloring nozzle 31 so that the valve element 44 leaves the base end 37a of the first nozzle member 37. Then, the coloring unit 15 spouts the coloring agent situated in the channel 39 of the coloring nozzle 31 with a specific amount thereof per spouting (that is, spouting the liquid coloring agent drop by drop) toward the electric wire 3.

Preferably, the coloring agent has viscosity equal to or less than 10 mPa·s (millipascal·second). The coloring agent means a liquid substance, in which a coloring material (organic substance for use in industry) is dissolved and dispersed in water or other solvent. The organic substance described above is a dye or a pigment (most of them being organic substances and synthetic substances). Sometimes, a dye is used as a pigment and a pigment is used as a dye. As an example, the coloring agent may be a coloring liquid or coating material.

The coloring liquid is a liquid, in which a dye is dissolved or dispersed in a solvent. The coating material is a material, in which a pigment is dispersed in a liquid dispersion. When the coloring liquid adheres to the outer surface 3a of the wire 3, the dye permeates into the coating 5. When the coating material adheres to the outer surface 3a of the wire 3, the pigment adheres to the outer surface 3a without permeating into the coating 5. That is, the coloring unit 15 dyes a part of the outer surface 3a of the wire 3 with a dye or, alternatively, coat a part of the outer surface 3a of the wire 3 with a pigment. In the specification, “to color the outer surface 3a of the electric wire 3” means to dye a part of the outer surface 3a of the coating 5 of the wire 3 with a dye or to coat a part of the outer surface 3a of the coating 5 of the wire 3 with a pigment.

Preferably, the solvent and liquid dispersion have an affinity to the synthetic resin that constitutes the coating 5 in order to securely permeate the dye into the coating 5 or to allow the pigment to securely adhere to the outer surface 3a of the coating 5.

In this specification, “spouting” means that the liquid coloring agent in a form of a liquid drop (or liquid drops) is ejected vigorously from the coloring nozzle 31 toward the outer surface 3a of the wire 3.

The duct 16 is placed on the delivery roll 12-side of the coloring unit 15. That is, the duct 16 is placed between the coloring unit 15 and the delivery roll 12. That is, the duct 16 is placed on the downstream side of the coloring unit 15 in the transferring direction K of the wire 3. The duct 16 is placed on the upstream side of the delivery roll 12 in the transferring direction K of the wire 3. The duct 16 is formed in a cylindrical shape and allows the wire 3 to pass therethrough. The duct 16 is connected to suction means (not shown in the figure) such as a vacuum pump. The suction means sucks gas existing in the duct 16 so as to prevent solvent or liquid dispersion existing in the coloring agent from being filled outside the coloring apparatus 1.

The encoder 17 is placed on the downstream side of the delivery roll 12 in the transferring direction K of the wire 3. As shown in FIG. 1, the encoder 17 includes a pair of rotors 47. Each rotor 47 is rotatably supported around the axis. The outer circumferential surface of the rotor 47 comes in contact with the outer surface 3a of the wire 3, which is put between the pair of the delivery rolls 12. When the wire 3 (i.e. core wire 4) is transferred in the direction K, the rotor 47 rotates around the axis. The amount of transfer of the wire 3 in the direction K is proportional to the number of revolutions of the rotor 47.

The encoder 17 is connected to the control device 19. When the rotor 47 rotates by a specific angle per rotation, the encoder 17 outputs a pulse signal to the control device 19. That is, the encoder 17 outputs an information corresponding to the transfer amount of the wire 3 in the direction K to the control device 19. Thus, the encoder 17 measures an information corresponding to the transfer amount of the wire 3 and outputs the information corresponding to the transfer amount of the wire 3 to the control device 19. Normally, the encoder 17 outputs a pulse signal corresponding to the transfer amount of the wire 3 on the basis of friction between the wire 3 and the rotor 47. However, in the event that the amount of the transfer of the wire 3 does not coincide with the number of the pulse due to a condition of the outer surface 3a of the wire 3, the speed information of the transfer of the wire 3 may be obtained from another position so that thus obtained speed information is subjected to feedback so as to make the output to be outputted to the control device 19.

The cutting mechanism 18 is placed on the downstream side of the pair of the rotors 47 of the encoder 17 in the transferring direction K of the wire 3. The cutting mechanism 18 includes a pair of cutting blades 48 and 49, each of which is arranged in the vertical direction. The cutting blades 48 and 49 approach or leave each other in the vertical direction. When the cutting blades 48 and 49 approach each other, they put the wire 3, which is delivered by the pair of the delivery rolls 12, therebetween and cut the wire 3. When the cutting blades 48 and 49 leave each other, they leave the wire 3.

The control device 19 is a computer including a known RAM, ROM and CPU. The control device 19 is connected to the delivery rolls 12, encoder 17, cutting mechanism 18, coloring nozzles 31 and so on. The control device 19 control the whole of the coloring apparatus 1 by controlling actions of these components described above.

The control device 19 stores a pattern of the mark 6 in advance. When the control device 19 receives a specific pulse signal from the encoder 17, i.e. an information corresponding to the amount of transfer of the wire 3, the control device 19 applies a current to the coil 40 of the predetermined coloring nozzle 31 for a specific period of time so that the coloring agent is spouted from the coloring nozzle 31 toward the wire 3 with a specific amount of the coloring agent per spouting. According to the pattern of the mark 6 stored in advance, the control device 19 shortens a time interval of the spouting of the coloring agent from the coloring nozzle 31 when the transfer speed of the wire 3 increases, while the control device 19 elongates a time interval of the spouting of the coloring agent from the coloring nozzle 31 when the transfer speed of the wire 3 decreases. Thus, the control device 19 performs the coloring of the wire 3 according to the pattern stored in advance. The control device 19 allows the coloring nozzle 31 to spout the coloring agent with a specific amount thereof per spouting on the basis of the amount of the transfer of the wire 3 measured by the encoder 17.

When the control device 19 judges that the wire 3 is transferred by a specific amount (i.e. distance) on the basis of the information from the encoder 17, the control device 19 halts the delivery roll 12, then allows the pair of the cutting blades 48 and 49 to approach each other so as to cut the wire 3.

As shown in FIG. 4, the coloring nozzle 31 includes a cylindrical nozzle body 34, insert member 35 received in the nozzle body 34, inlet pipe 36, first nozzle member 37 as the first nozzle part, valve mechanism 38, second nozzle member 50 as the second nozzle part, and connection pipe 51.

The insert member 35 is formed in a cylindrical shape and provided with a channel 39 to let the coloring agent pass therethrough. That is, the channel 39 is filled with the coloring agent supplied from the coloring agent supply source 32. The insert member 35 is the receiver for receiving the liquid coloring agent. The inlet pipe 36 communicates with the channel 39 to guide the coloring agent supplied from the coloring agent supply source 32 into the channel 39.

The first nozzle member 37 is formed in a cylindrical shape and communicates with the channel 39 so as to guide the coloring agent in the channel 39 to the outside of the coloring nozzle 31. The inner diameter D of the first nozzle member 37 is smaller than the inner diameter of the nozzle body 34, i.e. the outer diameter of the channel 39. The first nozzle member 37 is aligned with the nozzle body 34. The first nozzle member 37 is made of stainless steel.

The valve mechanism 38 includes a coil 40, valve body 41, and coil spring 42. The coil 40 is provided outside the channel 39 and embedded in the insert member 35. A current is applied to the coil 40 from the outside. The valve body 41 includes an electrically conductive body part 43 and valve element 44. The body part 43 integrally includes a cylindrical cylinder part 45 and disc-shaped disc part 46 which continues to an end of the cylinder part 45.

The disc part 46 of the body part 43 faces a base end 37a of the first nozzle member 37. The body part 43 is received in the channel 39 in a state that the longitudinal direction of the cylinder part 45 is parallel to that of the nozzle body 34. The body part 43 (or the valve body 41) is provided movably in the longitudinal direction of the cylinder part 45, i.e. the longitudinal direction of the nozzle body 34.

The valve element 44 is attached to the disc part 46 of the body part 43. That is, the valve element 44 is received in the insert member 35. The valve element 44 faces the base end 37a of the first nozzle member 37. The valve element 44 approaches or leaves the base end 37a of the first nozzle member 37.

When the valve element 44 comes in contact with the base end 37a of the first nozzle member 37, the coloring agent in the channel 39 is prevented from entering into the first nozzle member 37, that is, the watertight condition between the valve element 44 and the base end 37a is attained. When the valve element 44 leaves the base end 37a of the first nozzle member 37, the coloring agent is allowed to pass through the first nozzle member 37 and the second nozzle member 50 so as to be spouted toward the outer surface 3a of the wire 3.

Thus, the valve element 44 approaches or leaves the base end 37a between the opening position shown with an alternate long and two short dashes line in FIG. 4 and the closing position shown with a solid line in FIG. 4. At the opening position, the valve element 44 leaves the base end 37a, so that the coloring agent is allowed to pass through the first nozzle member 37 and the second nozzle member 50 so as to be spouted toward the outer surface 3a of the wire 3. At the closing position, the valve element 44 comes in contact with the base end 37a, so that the coloring agent is not allowed to pass through the first nozzle member 37 and the second nozzle member 50 to be spouted toward the outer surface 3a of the wire 3.

The coil spring 42 energizes the disc part 46 in such a direction that the valve element 44 approaches the base end 37a of the first nozzle member 37.

The second nozzle member 50 is formed in a cylindrical shape. The second nozzle member 50 is made of polyetheretherketone (PEEK). The outer diameter of the second nozzle member 50 is equal to that of the first nozzle member 37.

As shown in FIG. 5, the inner diameter d of the second nozzle member 50 is smaller than the inner diameter D of the first nozzle member 37. The second nozzle member 50 is aligned with the first nozzle member 37 and connected to the first nozzle member 37.

The second nozzle member 50 is disposed nearer to the wire 3 than the first nozzle member 37 is disposed near the wire 3. A watertight condition is attained between the first nozzle member 37 and the second nozzle member 50. The coloring agent flows through the first nozzle member 37 and the second nozzle member 50 in a direction of an arrow Q, i.e. in the longitudinal direction of the first nozzle member 37.

An end surface 50a of the second nozzle member 50 projects from an inner face of the first nozzle member 37 toward the inside of the first nozzle member 37. The end face 50a is adjacent to the first nozzle member 37. The end face 50a is formed flat in a direction crossing at right angles the direction of the arrow Q. The end face 50a is the step, which is formed between the first nozzle member 37 and the second nozzle member 50.

The connection pipe 51 is made of fluorine resin and formed in a cylindrical shape. The inner diameter of the connection pipe 51 is practically the same as the outer diameter of the first nozzle member 37 and the outer diameter the second nozzle member 50. The connection pipe 51 fits to both the outside of the first nozzle member 37 and the outside of the second nozzle member 50 so as to connect the first nozzle member 37 with the second nozzle member 50. The connection pipe 51 makes the second nozzle member 50 detachable from the first nozzle member 37.

The coloring nozzle 31 allows the coloring agent supplied from the coloring agent supply source 32 to flow through the inlet pipe 36 and guides the coloring agent into the channel 39. On a condition that a current is not applied to the coil 40, the valve element 44 comes in contact with the base end 37a of the first nozzle member 37 due to the energizing force by the coil spring 42, thereby the coloring agent stays within the channel 39.

When a current is applied to the coil 40, the valve element 44 attached to the disc part 46 leaves the base end 37a of the first nozzle member 37 against the energizing force by the coil spring 42, thereby allowing the coloring agent existing in the channel 39 to pass through the inside of the first nozzle member 37 and the second nozzle member 50 along the direction of the arrow Q. Thereby, the coloring nozzle 31 spouts the coloring agent from the second nozzle member 50. A current is applied to the coil 40 for a predetermined period of time on the basis of a command from the control device 15. Therefore, the coloring nozzle 31 spouts the coloring agent with a specific amount of the coloring agent per spouting toward the outer surface 3a of the wire 3.

The coloring nozzle 31 satisfies a condition expressed by the following expression (1):
8≦L/l≦10 (1),
wherein L is the sum of a length of the first nozzle member 37 and a length of the second nozzle member 50 in the direction of the arrow Q, and l is the length of the second nozzle member 50 in the direction of the arrow Q.

Further, the coloring nozzle 31 satisfies a condition expressed by the following expression (2):
4≦D/d≦6 (2),
wherein D is an inner diameter of the first nozzle member 37, and d is an inner diameter of the second nozzle member 50.

When the mark 6 is formed on the outer surface 3a of the wire 3, i.e. when the outer surface 3a of the wire 3 is colored in the coloring apparatus 1, first the guide roll 11 is attached to the frame 10. Keeping the cutting blades 48 and 49 apart from each other, the wire 3 wound up around the guide roll 11 is passed through the correction unit 13, slack absorbing unit 14, coloring unit 15 and duct 16 in sequence and is put between the pair of the delivery rolls 12. Then, the coloring nozzle 31 is attached to a specific position of the unit body 30 of the coloring unit 15 and the coloring agent supply sources 32 are connected to the respective coloring nozzles 31. Further, the pressurized gas supply source 33 is connected to the coloring agent supply sources 32 and the gas existed in the duct 16 is sucked by the suction means.

Then, the delivery rolls 12 are driven so that the wire 3 is pulled from the guide roll 11 so as to be transferred in the longitudinal direction of the wire 3. The correction unit 13 gives friction force of the first bias force H1 to the wire 3 so as to stretch the wire 3. Then, the air cylinder 27 gives the second bias force H2 to the transfer roller 26, that is, to the wire 3.

When a pulse signal of specific sequence is inputted to the control device 19 from the encoder 17, the control device 19 applies a current to the coil 40 of the coloring nozzle 31 for a specific period of time per a specific time interval. Then, the coloring nozzle 31 spouts the coloring agent toward the outer surface 3a of the wire 3 with a specific amount thereof per spouting.

Then, the solvent or liquid dispersion is evaporated from the coloring agent adhered to the outer surface 3a of the wire 3, so that the outer surface 3a is dyed with a dye or coated with a pigment. The solvent or liquid dispersion evaporated from the coloring agent adhered to the outer surface 3a is sucked by the suction means from the duct 16. Thus, the outer surface 3a of the wire 3 is colored.

When the control device 19 judges that the wire 3 is transferred by a specific amount (i.e. distance) on the basis of the information from the encoder 17, the control device 19 halts the delivery roll 12. Then, the wire 3 slackens between the pair of the guide rollers 24 in the slack absorbing unit 14 and then, the transfer roller 26, which is energized with the second bias force H2 is shifted to a position indicated by an alternate long and two short dashes line in FIG. 1. Then, the stretchable rod 29 of the air cylinder 27 in the slack absorbing unit 14 stretches. Thus, the slack absorbing unit 14 absorbs the slack of the wire 3.

Then, the cutting blades 48 and 49 approach each other, put the wire 3 therebetween and cut the wire 3. Thus, the wire 3 shown in FIG. 6, the outer surface 3a of which is provided with the mark 6, is obtained.

When the liquid coloring agent is spouted from the coloring nozzle 31 toward the outer surface 3a of the wire 3 with a specific amount thereof per spouting, a part of the coloring agent that flows in the first nozzle member 37 and second nozzle member 50 in the direction of the arrow Q (i.e. along the center axis R) collides against the end surface 50a of the second nozzle member 50. Then, the part of the coloring agent collided against the end surface 50a causes the occurrence of a vortex so as to stir the coloring agent. Thereby, the concentration of the coloring agent existed in the second nozzle member 50 is maintained uniform.

Further, when the liquid coloring agent is spouted from the coloring nozzle 31 toward the outer surface 3a of the wire 3 with a specific amount thereof per spouting, when the coloring agent enters into the first nozzle member 37 from the channel 39, as shown in FIG. 8B, the pressure of the coloring agent increases. The pressure of the coloring agent is approximately constant within the first nozzle member 37. When a part of the coloring agent collides against the end surface 50a, the pressure of the coloring agent rapidly increases. Thereafter, when the coloring agent is spouted from the second nozzle member 50 toward the outer surface 3a of the wire 3, the pressure of the coloring agent rapidly decreases.

Furthermore, when the liquid coloring agent is spouted from the coloring nozzle 31 toward the outer surface 3a of the wire 3 with a specific amount thereof per spouting, as shown in FIG. 8C, when the coloring agent enters into the first nozzle member 37 from the channel 39, the velocity (i.e. velocity of flow) of the coloring agent decreases. The velocity of the coloring agent is roughly constant within the first nozzle member 37 but decreases a little as the coloring agent approaches the second nozzle member 50.

When a part of the coloring agent collides against the end surface 50a, the velocity of the coloring agent rapidly increases. Thereafter, when the coloring agent is spouted from the second nozzle member 50 toward the outer surface 3a of the wire 3, the velocity of the coloring agent is maintained high. Thus, when the coloring agent enters into the second nozzle member 50, the pressure and the velocity of the coloring agent rapidly increase. That is, the liquid coloring agent having high pressure and high velocity is spouted toward the outer surface 3a of the electric wire 3.

According to the preferred embodiments described above, the coloring agent collides against the end surface 50a of the second nozzle member 50 so as to be stirred. Since the first nozzle member 37 is aligned with the second nozzle member 50 and the end surface 50a crosses at right angles the direction of the arrow Q, the coloring agent is securely stirred. Accordingly, the concentration of a dye or pigment in the coloring agent is maintained uniform. That is, it can be avoided that an abnormally concentrated coloring agent adheres to the second nozzle member 50.

When the coloring agent enters into the second nozzle member 50 from the first nozzle member 37, the coloring agent is rapidly pressurized. Therefore, the coloring agent is vigorously spouted from the second nozzle member 50 toward the outer surface 3a of the wire 3, thereby preventing the coloring agent from adhering to the second nozzle member 50.

Since the coloring agent is prevented from adhering to the second nozzle member 50, the coloring agent with a specific amount thereof per spouting can be spouted securely from the second nozzle member 50 toward the outer surface 3a of the wire 3. Further, since the coloring agent is prevented from adhering to the second nozzle member 50, it can be prevented that the coloring agent that has adhered to the second nozzle member 50 influences a direction in which the coloring agent is spouted. Therefore, the coloring agent with a specific amount thereof per spouting can be spouted securely toward a desired position on the outer surface 3a of the wire 3. The desired position on the outer surface 3a of the wire 3 can be colored with a desired color. The colored position can be maintained to have a desired area (i.e. size).

The coloring nozzle 31 spouts the coloring agent toward the wire 3 with a specific amount thereof per spouting while the wire 3 is transferred relatively to the coloring nozzle 31 in the longitudinal direction of the wire 3. Thus, the wire 3 is colored while the wire 3 is transferred relatively to the coloring nozzle 31. Since it is not necessary to halt the movement of the wire 3 in order to color the wire 3, thereby preventing the workability from being deteriorated. Since the coloring nozzle 31 spouts the coloring agent toward the wire 3 with a specific amount thereof per spouting while the wire 3 is transferred relatively to the coloring nozzle 31, a desired position of the wire 3 can be colored and the wire 3 can be colored continuously.

The encoder 17 measures the amount of the transfer of the wire 3 and the control device 19 controls the coloring nozzle 31 according to the amount of the transfer of the wire 3. The control device 19 shortens a time interval of the spouting of the coloring agent from the coloring nozzle 31 when the transfer speed of the wire 3 increases, while the control device 19 elongates a time interval of the spouting of the coloring agent from the coloring nozzle 31 when the transfer speed of the wire 3 decreases. Thus, even if the transfer speed of the wire 3 is changed, a distance between the positions on the outer surface 3a of the wire 3, to which positions the coloring agent has adhered, can be maintained constant.

Therefore, even if the transfer speed of the wire 3 is changed, the coloring agent can adhere to the outer surface 3a of the wire 3 according to a predetermined pattern. That is, even if the transfer speed of the wire 3 is changed, the wire 3 can be colored according to a predetermined pattern.

The effect of the coloring nozzle 31 constituted as described above was actually examined. First, on a condition that the value of D/d was set constant, an adhesion characteristic of the coloring agent to the second nozzle member 50 and a spouting characteristic of the coloring agent were evaluated with changing the value of L/l. The result is shown in Table 1.

TABLE 1
Adhesion characteristic of coloring agent depending on
change in L/1 when D/d is set constant

| | | Adhesion | Uniformity of | |
|---|---|---|---|---|
| | | characteristic | amount of | |
| | | of coloring agent | coloring agent | |
| | | to second nozzle | spouted from second | |
| | L/1 | member | nozzle member | Evaluation |
| Comparative | 5 | Some adhesion | Not uniform | Not good |
| Example A | | | | |
| Comparative | 6 | Some adhesion | Not uniform | Not good |
| Example B | | | | |
| Comparative | 7 | Little adhesion | Not uniform | Not good |
| Example C | | | | |
| Example A | 8 | Little adhesion | Practically uniform | Good |
| Example B | 9 | Little adhesion | Practically uniform | Good |
| Example C | 10 | Little adhesion | Practically uniform | Good |
| Comparative | 11 | Little adhesion | Coloring agent | Not good |
| Example D | | | liquid drops | |
| | | | being scattered | |

In the examination described above, a coloring agent having viscosity approximately equal to 10 mPa·s (millipascal·second) was used and the value of D/d was set to be 5. The length l of the second nozzle member 50 was varied, that is, the value of L/l was set to be 5, 6, 7 and 11 for Comparative Examples A, B, C and D, respectively. Further, the value of L/l was set to be 8, 9 and 10 for Examples A, B and C according to the present invention, respectively.

As shown in Table 1, as for the Comparative Examples A and B, some amount of the coloring agent adhered to the second nozzle member 50. This result seems to be attributed to that since a difference between a volume within the first nozzle member 37 and a volume within the second nozzle member 50 was small, even when the coloring agent entered from the first nozzle member 37 into the second nozzle member 50, the pressure of the coloring agent did not increase sufficiently, that is, the coloring agent was not compressed (i.e. pressurized) sufficiently, accordingly, the coloring agent spouted from the second nozzle member 50 was not given sufficient force, resulting in that some amount of the coloring agent adhered to the second nozzle member 50.

Moreover, as for the Comparative Examples A and B, the amount (i.e. volume) of the liquid drop (or drops) of the coloring agent spouted from the second nozzle member 50 was not uniform. This result seems to be attributed to that since the coloring agent was not compressed (i.e. pressurized) sufficiently, accordingly the coloring agent spouted from the second nozzle member 50 was not given sufficient force, resulting in that the amount (i.e. volume) of the liquid drop (or drops) of the coloring agent spouted from the second nozzle member 50 was not uniform.

As for the Comparative Example C, the coloring agent hardly adhered to the second nozzle member 50, however, the amount (i.e. volume) of the liquid drop (or drops) of the coloring agent spouted from the second nozzle member 50 was not uniform. This result seems to be attributed to that since the coloring agent was not compressed (i.e. pressurized) sufficiently, accordingly the coloring agent spouted from the second nozzle member 50 was not given sufficient force, resulting in that the amount (i.e. volume) of the liquid drop (or drops) of the coloring agent spouted from the second nozzle member 50 was not uniform.

As for the Comparative Example D, the coloring agent hardly adhered to the second nozzle member 50. This result seems to be attributed to that since a difference between a volume within the first nozzle member 37 and a volume within the second nozzle member 50 was large, when the coloring agent entered from the first nozzle member 37 into the second nozzle member 50, the pressure of the coloring agent increased sufficiently, that is, the coloring agent was compressed (i.e. pressurized) sufficiently, accordingly, the coloring agent spouted from the second nozzle member 50 was given sufficient force, resulting in that the coloring agent hardly adhered to the second nozzle member 50.

However, as for the Comparative Example D, the liquid drop (or drops) of the coloring agent spouted from the second nozzle member 50 was scattered. This result seems to be attributed to that since the coloring agent was compressed (i.e. pressurized) sufficiently more than enough (i.e. compressed too much), that is, the coloring agent spouted from the second nozzle member 50 was given sufficient force more than enough (i.e. given too much force), therefore the coloring agent tended to expand rapidly when the coloring agent is spouted from the second nozzle member 50, resulting in that the liquid drop (or drops) of the coloring agent spouted from the second nozzle member 50 was scattered.

On the other hand, as for the Examples A, B and C according to the present invention, the coloring agent hardly adhered to the second nozzle member 50. This result seems to be attributed to that since a difference between a volume within the first nozzle member 37 and a volume within the second nozzle member 50 was sufficiently large and not large more than enough (i.e. not too large), when the coloring agent entered from the first nozzle member 37 into the second nozzle member 50, the coloring agent was compressed (i.e. pressurized) sufficiently and not compressed (i.e. pressurized) more than enough (i.e. not compressed too much), accordingly, the coloring agent spouted from the second nozzle member 50 was given sufficient force, resulting in that the coloring agent hardly adhered to the second nozzle member 50.

Moreover, as for the Examples A, B and C according to the present invention, the amount (i.e. volume) of the liquid drop (or drops) of the coloring agent spouted from the second nozzle member 50 was practically uniform. This result seems to be attributed to that since the coloring agent was compressed (i.e. pressurized) sufficiently and not compressed (i.e. pressurized) more than enough (i.e. not compressed too much), accordingly, the coloring agent spouted from the second nozzle member 50 was given sufficient force, resulting in that the amount (i.e. volume) of the liquid drop (or drops) of the coloring agent spouted from the second nozzle member 50 was practically uniform and that the liquid drop (or drops) of the coloring agent spouted from the second nozzle member 50 was not scattered.

Thus, according to the results shown in Table 1, it is demonstrated that if the coloring nozzle 31 satisfies the condition expressed by the expression (1) (that is, 8≦L/l≦10), the coloring agent hardly adheres to the second nozzle member 50 and the amount of the liquid drop (or drops) of the coloring agent spouted from the second nozzle member 50 is practically uniform. That is, if the condition expressed by the expression (1) is satisfied, when the coloring agent entered from the first nozzle member 37 into the second nozzle member 50, the coloring agent is pressurized so as to maintain a form of the liquid drop upon spouting and so as to be spouted toward a desired direction.

Accordingly, the coloring agent in a form of a liquid drop is securely spouted toward the desired position on the outer surface 3a of the wire 3 with a specific amount thereof per spouting. The desired position on the outer surface 3a of the wire 3 can be colored with a desired color and the colored position, i.e. the spot 7 can be maintained to have a desired area (i.e. size).

The effect of the coloring nozzle 31 was further examined. On a condition that the value of L/l was set constant, an adhesion characteristic of the coloring agent to the second nozzle member 50 and a spouting characteristic of the coloring agent were evaluated with changing the value of D/d. The result is shown in Table 2.

TABLE 2
Adhesion characteristic of coloring agent depending on
change in D/d when L/1 is set constant

| | | | Uniformity | |
|---|---|---|---|---|
| | | Adhesion | of amount of | |
| | | characteristic | coloring agent | |
| | | of coloring agent | spouted from | |
| | | to second | second nozzle | |
| | D/d | nozzle member | member | Evaluation |
| Comparative | 2 | Some adhesion | Not uniform | Not good |
| Example E | | | | |
| Comparative | 3 | Some adhesion | Not uniform | Not good |
| Example F | | | | |
| Example D | 4 | Little adhesion | Practically uniform | Good |
| Example E | 5 | Little adhesion | Practically uniform | Good |
| Example F | 6 | Little adhesion | Practically uniform | Good |
| Comparative | 7 | Little adhesion | Coloring agent | Not good |
| Example G | | | liquid drops | |
| | | | being scattered | |

In the examination described above, a coloring agent having viscosity approximately equal to 10 mPa·s (millipascal·second) was used and the value of L/l was set to be 9. The inner diameter d of the second nozzle member 50 was varied, that is, the value of D/d was set to be 2, 3 and 7 for Comparative Examples E, F and G, respectively. Further, the value of D/d was set to be 4, 5 and 6 for Examples D, E and F according to the present invention, respectively.

As shown in Table 2, as for the Comparative Examples E and F, some amount of the coloring agent adhered to the second nozzle member 50. This result seems to be attributed to that since a difference between a volume within the first nozzle member 37 and a volume within the second nozzle member 50 was small, even when the coloring agent entered from the first nozzle member 37 into the second nozzle member 50, the pressure of the coloring agent did not increase sufficiently, that is, the coloring agent was not compressed (i.e. pressurized) sufficiently, accordingly, the coloring agent spouted from the second nozzle member 50 was not given sufficient force, resulting in that some amount of the coloring agent adhered to the second nozzle member 50.

Moreover, as for the Comparative Examples E and F, the amount (i.e. volume) of the liquid drop (or drops) of the coloring agent spouted from the second nozzle member 50 was not uniform. This result seems to be attributed to that since the coloring agent was not compressed (i.e. pressurized) sufficiently, accordingly the coloring agent spouted from the second nozzle member 50 was not given sufficient force, resulting in that the amount (i.e. volume) of the liquid drop (or drops) of the coloring agent spouted from the second nozzle member 50 was not uniform.

As for the Comparative Example G, the coloring agent hardly adhered to the second nozzle member 50. This result seems to be attributed to that since a difference between a volume within the first nozzle member 37 and a volume within the second nozzle member 50 was large, when the coloring agent entered from the first nozzle member 37 into the second nozzle member 50, the coloring agent was compressed (i.e. pressurized) sufficiently, accordingly, the coloring agent spouted from the second nozzle member 50 was given sufficient force, resulting in that the coloring agent hardly adhered to the second nozzle member 50.

However, as for the Comparative Example G, the liquid drop (or drops) of the coloring agent spouted from the second nozzle member 50 was scattered. This result seems to be attributed to that since the coloring agent was compressed (i.e. pressurized) sufficiently more than enough (i.e. compressed too much), that is, the coloring agent spouted from the second nozzle member 50 was given sufficient force more than enough (i.e. given too much force), therefore the coloring agent tended to expand rapidly when the coloring agent is spouted from the second nozzle member 50, resulting in that the liquid drop (or drops) of the coloring agent spouted from the second nozzle member 50 was scattered.

On the other hand, as for the Examples D, E and F according to the present invention, the coloring agent hardly adhered to the second nozzle member 50. This result seems to be attributed to that since a difference between a volume within the first nozzle member 37 and a volume within the second nozzle member 50 was sufficiently large and not large more than enough (i.e. not too large), when the coloring agent entered from the first nozzle member 37 into the second nozzle member 50, the coloring agent was compressed (i.e. pressurized) sufficiently and not compressed (i.e. pressurized) more than enough (i.e. not compressed too much), accordingly, the coloring agent spouted from the second nozzle member 50 was given sufficient force, resulting in that the coloring agent hardly adhered to the second nozzle member 50.

Moreover, as for the Examples D, E and F according to the present invention, the amount (i.e. volume) of the liquid drop (or drops) of the coloring agent spouted from the second nozzle member 50 was practically uniform. This result seems to be attributed to that since the coloring agent was compressed (i.e. pressurized) sufficiently and not compressed (i.e. pressurized) more than enough (i.e. not compressed too much), accordingly, the coloring agent spouted from the second nozzle member 50 was given sufficient force, resulting in that the amount (i.e. volume) of the liquid drop (or drops) of the coloring agent spouted from the second nozzle member 50 was practically uniform and that the liquid drop (or drops) of the coloring agent spouted from the second nozzle member 50 was not scattered.

Thus, according to the results shown in Table 2, it is demonstrated that if the coloring nozzle 31 satisfies the condition expressed by the expression (2) (that is, 4≦D/d≦6), the coloring agent hardly adheres to the second nozzle member 50 and the amount of the liquid drop (or drops) of the coloring agent spouted from the second nozzle member 50 is practically uniform. That is, if the condition expressed by the expression (2) is satisfied, when the coloring agent entered from the first nozzle member 37 into the second nozzle member 50, the coloring agent is pressurized so as to maintain a form of the liquid drop upon spouting and so as to be spouted toward a desired direction.

Accordingly, the coloring agent in a form of a liquid drop is securely spouted toward the desired position on the outer surface 3a of the wire 3 with a specific amount thereof per spouting. The desired position on the outer surface 3a of the wire 3 can be colored with a desired color and the colored position, i.e. the spot 7 can be maintained to have a desired area (i.e. size).

The effect of the coloring nozzle 31 was further examined. An adhesion characteristic of the coloring agent to the second nozzle member 50 was evaluated when the second nozzle member 50, which satisfied both conditions expressed by the expressions (1) and (2), was made of various materials. The result is shown in Table 3.

TABLE 3
Adhesion characteristic of coloring agent depending on
nozzle material

| | | Adhesion characteristic | |
|---|---|---|---|
| | Material of | of coloring agent | |
| | second nozzle | to second nozzle | |
| | member | member | Evaluation |
| Comparative | Stainless steel | Some adhesion | Not good |
| Example H | | | |
| Comparative | Ceramic | Some adhesion | Not good |
| Example I | | | |
| Comparative | Fluorine resin | Some adhesion | Not good |
| Example J | | | |
| Example | PEEK | Little adhesion | Good |

In the examination described above, a coloring agent having viscosity approximately equal to 10 mPa·s (millipascal·second) was used and the value of D/d was set to be 5, and the value of L/l was set to be 9. The material of the second nozzle member 50 was varied, that is, the material was stainless steel, ceramic and fluorine resin for Comparative Examples H, I and J, respectively. Further, the material of the second nozzle member 50 was polyetheretherketone (PEEK) for an Example according to the present invention.

As shown in Table 3, as for the Comparative Examples H, I and J, some amount of the coloring agent adhered to the second nozzle member 50. On the other hand, as for the Example according to the present invention, the coloring agent hardly adhered to the second nozzle member 50.

Thus, according to the result shown in Table 3, if the second nozzle member 50 is made of PEEK, the coloring agent hardly adhered to the second nozzle member 50. That is, by manufacturing the second nozzle member 50 made of PEEK, it can be prevented that the coloring agent that has adhered to the second nozzle member 50 influences a direction in which the coloring agent is spouted. Therefore, the coloring agent with a specific amount thereof per spouting can be spouted securely toward a desired position on the outer surface 3a of the wire 3. The desired position on the outer surface 3a of the wire 3 can be colored with a desired color. The colored position, i.e. the spot 7 can be maintained to have a desired area (i.e. size).

In the preferred embodiment described above, as the step, the end surface 50a of the second nozzle member 50 projects from an inner face of the first nozzle member 37 toward the inside of the first nozzle member 37 and the end surface 50a is formed flat in a direction crossing at right angles the direction of the arrow Q. However, instead, as shown in FIGS. 9A, 9B, 10A, 10B, 11A and 11B, a tapered surface 60 may be formed as the step, which projects from an inner face of the first nozzle member 37 toward the inside of the first nozzle member 37.

The tapered surface 60 continues to both inner surfaces of the first and second nozzle members 37 and 50, and provided between the first and second nozzle members 37 and 50. As shown in FIGS. 9A, 9B, 10A, 10B, 11A and 11B, a tapered surface 60 is formed flat in a direction crossing both the direction of the arrow Q and the direction crossing at right angles the direction of the arrow Q.

In an example shown in FIGS. 9A and 9B, the tapered surface 60 is formed only on the second nozzle member 50. In an example shown in FIGS. 10A and 10B, the tapered surface 60 is formed only on the first nozzle member 37. In an example shown in FIGS. 11A and 11B, the tapered surface 60 is formed on both the first nozzle member 37 and the second nozzle member 50, that is, the tapered surface 60 is formed over both the first nozzle member 37 and the second nozzle member 50. Thus, the tapered surface 60 as the step is formed on at least one of the first nozzle member 37 and the second nozzle member 50.

As shown in FIGS. 9A, 9B, 10A, 10B, 11A and 11B, if the tapered surface 60 is formed as the step, the coloring nozzle 31 may satisfy both conditions expressed by the expressions (1) and (2) and the second nozzle member 50 may be made of PEEK.

According to the examples shown in FIGS. 9A, 9B, 10A, 10B, 11A and 11B, the tapered surface 60 is formed flat in a direction crossing both the direction of the arrow Q and the direction crossing at right angles the direction of the arrow Q. Accordingly, the tapered surface 60 allows the inner diameters of the first and second nozzle members 37, 50 to gradually decrease as approaching an end of the second nozzle member 50.

Therefore, the coloring agent that flows in the first and second nozzle members 37, 50 in the direction of the arrow Q is gradually pressurized and accelerated by the tapered surface 60. Therefore, the coloring agent that flows in the first and second nozzle members 37, 50 is prevented from rapidly pressurized. Therefore, air bubbles are prevented from occurring in the coloring agent. Accordingly, the coloring agent to be spouted from the nozzle part toward the outer surface 3a of the wire 3 is securely spouted in a form of a liquid drop (or liquid drops). Therefore, the coloring agent can securely adhere to the desired position on the wire 3 without scattering to an undesired position. That is, the desired position of the outer surface 3a of the wire 3 can be securely colored.

In the example of the preferred embodiment described above, the coloring nozzle 31 satisfies both conditions expressed by the expressions (1) and (2). However, instead, the coloring nozzle 31 may satisfy at least one of the two conditions. Further, in the preferred embodiment described above, the first and second nozzle members 37 and 50 are not in one piece. However, instead, the first and second nozzle members 37 and 50 may be in one piece.

In the example of the preferred embodiment described above, the coloring nozzle 31 satisfies both conditions expressed by the expressions (1) and (2), and the second nozzle member 50 is made of PEEK. However, instead, if the second nozzle member 50 is made of PEEK, the coloring nozzle 31 may not necessarily satisfy conditions expressed by the expressions (1) and (2). Further, if the coloring nozzle 31 satisfies at least one of the two conditions expressed by the expressions (1) and (2), the second nozzle member 50 may not necessarily be made of PEEK.

In the present invention, as the coloring liquid or coating material, various material may be used, such as acrylic coating material, ink (dye or pigment) and UV-ink.

The aforementioned preferred embodiments are described to aid in understanding the present invention and variations may be made by one skilled in the art without departing from the spirit and scope of the present invention.

### BRIEF DESCRIPTION OF THE DRAWINGS

FIG. 1 is a side view illustrating a structure of an apparatus for coloring an electric wire according to a preferred embodiment of the present invention.

FIG. 2 is a cross sectional view illustrating a coloring unit of the apparatus for coloring an electric wire taken along II-II line shown in FIG. 1.

FIG. 3 illustrates a positional relation among respective coloring nozzles in the coloring unit shown in FIG. 2 and an electric wire.

FIG. 4 is a cross sectional view illustrating a structure of each coloring nozzle in the coloring unit shown in FIG. 2.

FIG. 5 is a cross sectional view illustrating the first and second nozzle members of the coloring nozzle shown in FIG. 4.

FIG. 6A is a perspective view of an electric wire colored by the apparatus for coloring an electric wire shown in FIG. 1.

FIG. 6B is a plan view of the electric wire shown in FIG. 6A.

FIG. 7 is a view illustrating a state when the coloring agent is spouted from the coloring nozzle shown in FIG. 4.

FIGS. 8A-8C are views illustrating a relation between respective positions in the coloring nozzle and pressure and velocity of the coloring agent when the coloring agent is spouted from the coloring nozzle shown in FIG. 4, wherein FIG. 8A being a view illustrating the respective positions in the coloring nozzle, FIG. 8B illustrating a relation between the respective positions of the coloring nozzle and the pressure of the coloring agent, and FIG. 8C illustrating a relation between the respective positions of the coloring nozzle and the velocity of the coloring agent.

FIGS. 9A and 9B are cross sectional views illustrating another example of the first and second nozzle members of the coloring nozzle shown in FIG. 5, wherein FIG. 9A being a cross sectional view illustrating the whole of the first and second nozzle members and FIG. 9B being a cross sectional view illustrating a primary part of the first and second nozzle members.

FIGS. 10A and 10B are cross sectional views illustrating further example of the first and second nozzle members of the coloring nozzle shown in FIG. 5, wherein FIG. 10A being a cross sectional view illustrating the whole of the first and second nozzle members and FIG. 10B being a cross sectional view illustrating a primary part of the first and second nozzle members.

FIGS. 11A and 11B are cross sectional views illustrating still further example of the first and second nozzle members of the coloring nozzle shown in FIG. 5, wherein FIG. 11A being a cross sectional view illustrating the whole of the first and second nozzle members and FIG. 11B being a cross sectional view illustrating a primary part of the first and second nozzle members.

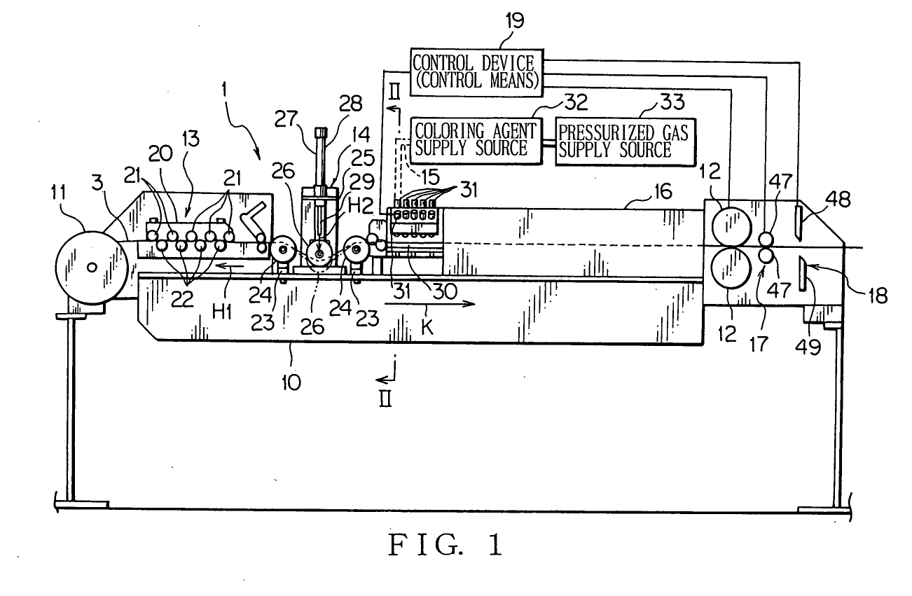

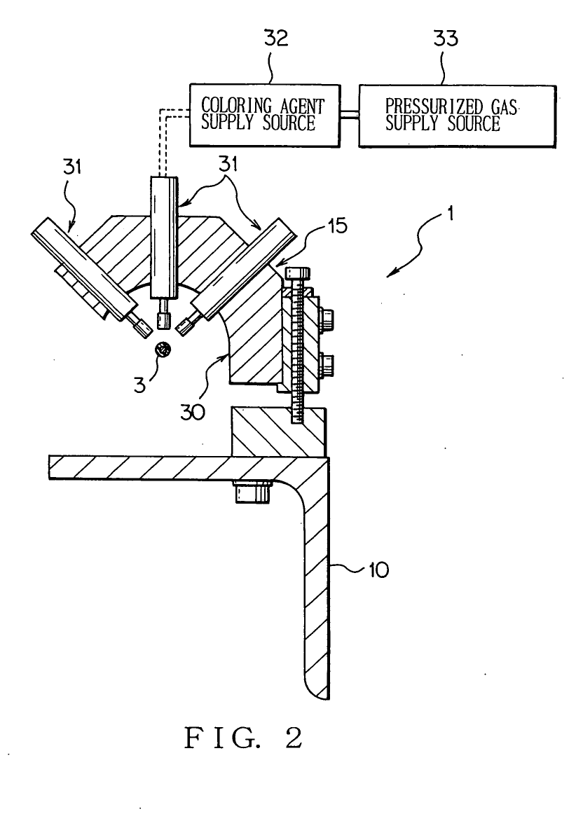

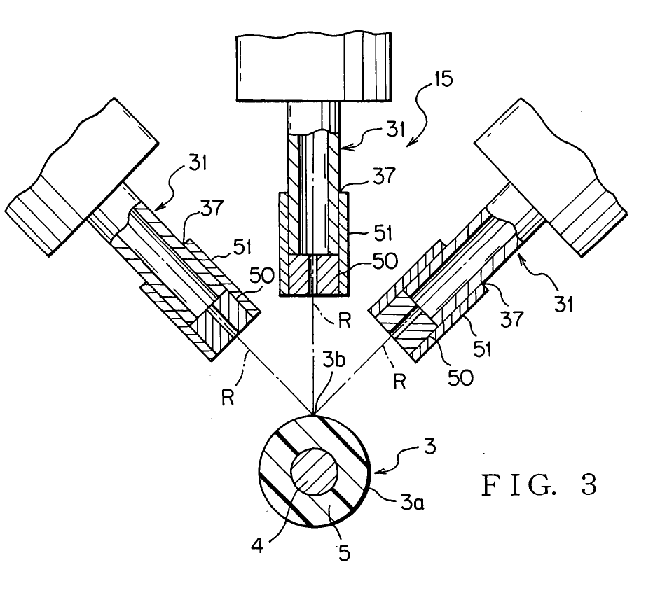

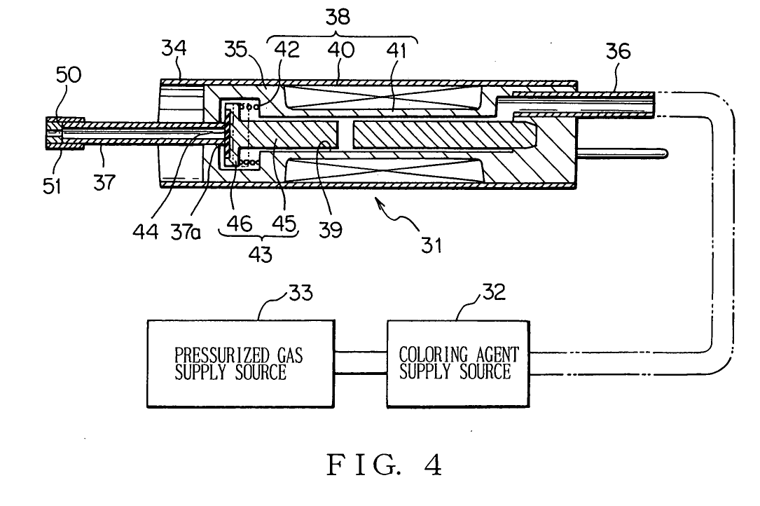

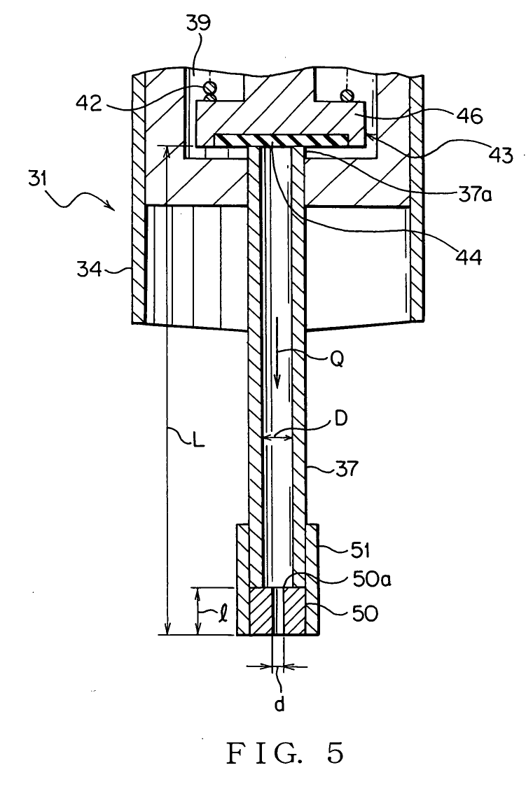

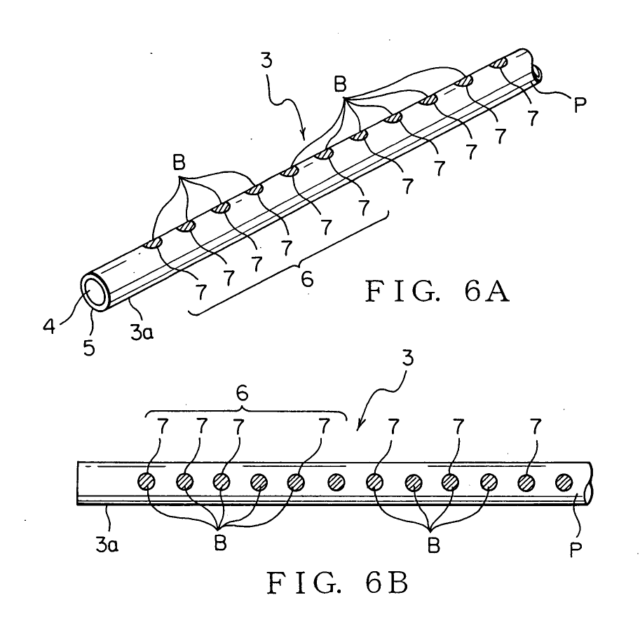

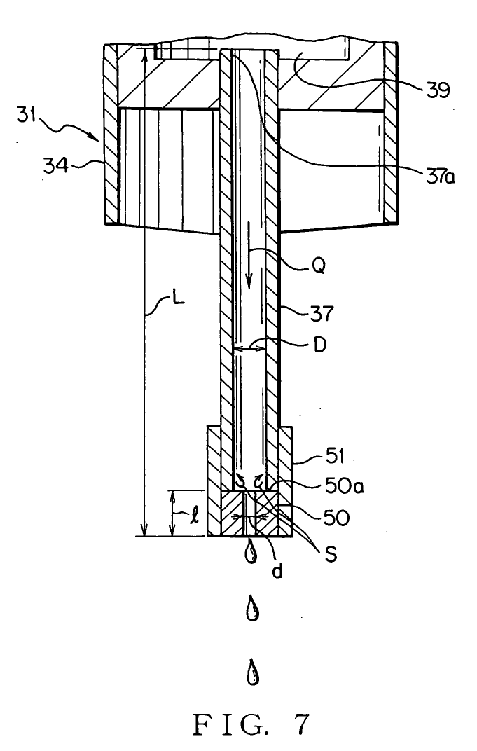

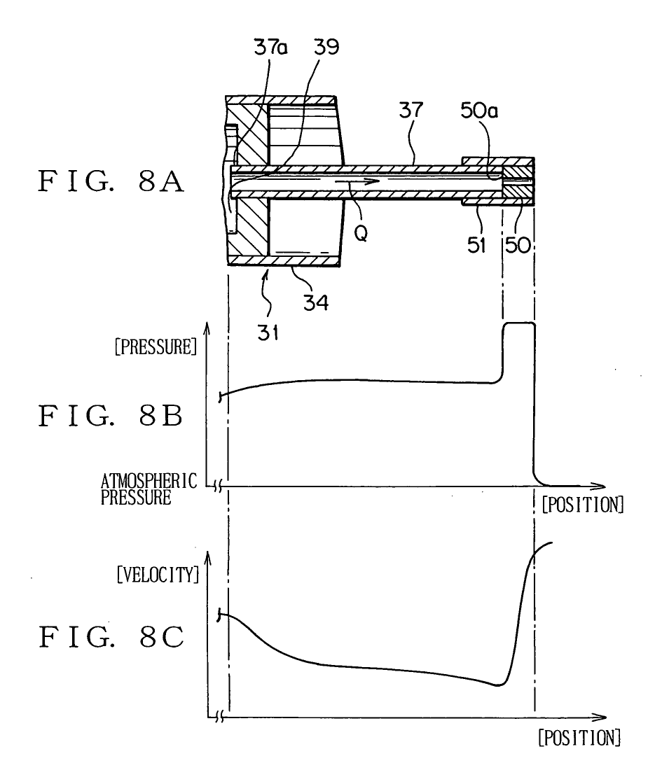

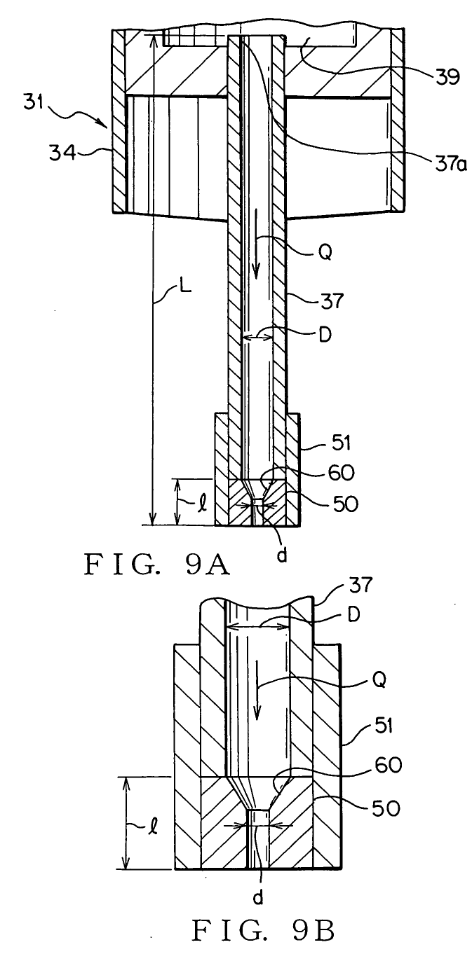

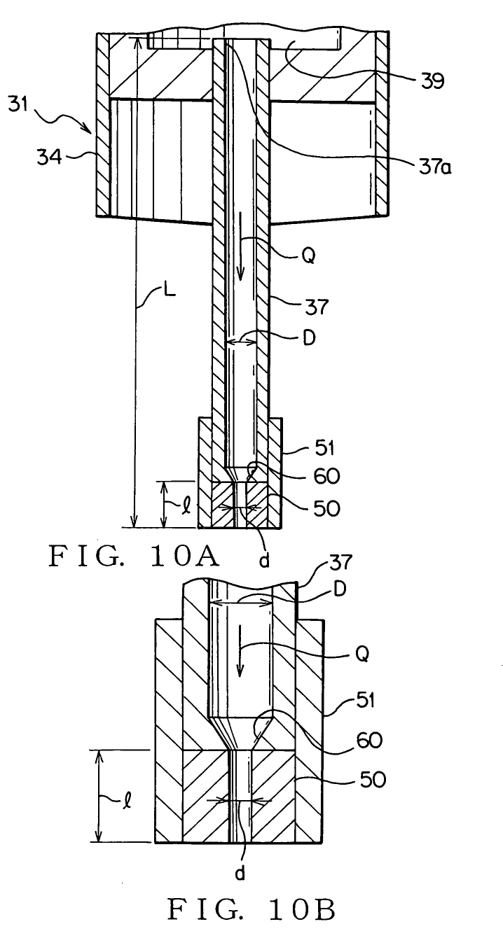

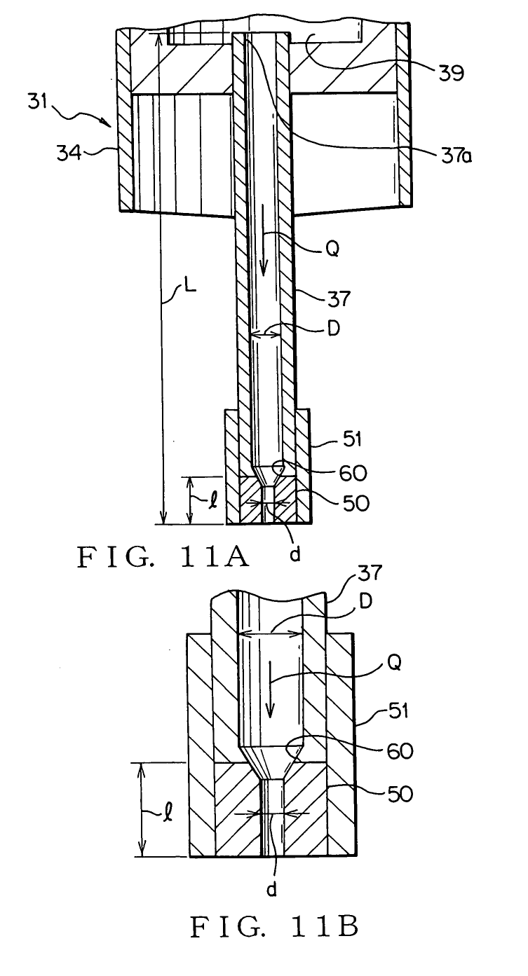

### ABBREVIATION NUMERALS

3 electric wire
3a outer surface
31 nozzle for coloring electric wire
35 insert member (receiver)
37 first nozzle member (first nozzle part)
50 second nozzle member (second nozzle part)
50a end surface (step)
60 tapered surface (step)
Q flow direction of coloring agent

1. A nozzle for coloring an electric wire, which spouts a liquid coloring agent with a specific amount thereof per spouting toward an outer surface of the electric wire so that a liquid drop of the coloring agent adheres to the outer surface of the electric wire, the nozzle comprising:
a receiver for receiving the coloring agent therein;
a first nozzle part formed in a cylindrical shape for allowing the coloring agent to pass therethrough, the first nozzle part communicating with the receiver; and
a second nozzle part formed in a cylindrical shape having an inner diameter smaller than that of the first nozzle part for allowing the coloring agent to pass therethrough, the second nozzle part being connected to the first nozzle part,
wherein the second nozzle part is disposed nearer to the electric wire than the first nozzle part is disposed,
wherein between the first and second nozzle parts there is formed a step protruding from an inner surface of the first nozzle part toward the inside of the first nozzle part.

2. The nozzle for coloring an electric wire according to claim 1, wherein the step is formed flat in a direction crossing at right angles a direction in which the coloring agent flows in the first and second nozzle parts.

3. The nozzle for coloring an electric wire according to claim 1, wherein the step is formed flat in a direction crossing both a direction in which the coloring agent flows in the first and second nozzle parts and a direction crossing at right angles the direction in which the coloring agent flows.

4. The nozzle for coloring an electric wire according to claim 3, wherein the step is formed on at least one of the first and second nozzle parts.

5. The nozzle for coloring an electric wire as claimed in claim 1, wherein the first and second nozzle parts are connected coaxially to each other.

6. The nozzle for coloring an electric wire as claimed in claim 1, satisfying a condition of 8≦L/l<10, wherein L is the sum of a length of the first nozzle part and a length of the second nozzle part in a direction in which the coloring agent flows, and l is the length of the second nozzle part in the direction in which the coloring agent flows.

7. The nozzle for coloring an electric wire as claimed claim 1, satisfying a condition of 4≦D/d≦6, wherein D is an inner diameter of the first nozzle part, and d is an inner diameter of the second nozzle part.

8. The nozzle for coloring an electric wire as claimed in claim 1, satisfying a condition of 8≦L/l≦10, wherein L is the sum of a length of the first nozzle part and a length of the second nozzle part in a direction in which the coloring agent flows, and l is the length of the second nozzle part in the direction in which the coloring agent flows, and satisfying a condition of 4≦D/d≦6, wherein D in an inner diameter of the first nozzle part, and d is an inner diameter of the second nozzle part.

9. The nozzle for coloring an electric wire as claimed in claim 1, wherein the second nozzle part is made of polyetheretherketone.

10. A nozzle for coloring an electric wire, which spouts a liquid coloring agent with a specific amount thereof per spouting toward an outer surface of the electric wire so that a liquid drop of the coloring agent adheres to the outer surface of the electric wire, the nozzle comprising:
a receiver for receiving the coloring agent therein;
a first nozzle part formed in a cylindrical shape for allowing the coloring agent to pass therethrough, the first nozzle part communicating with the receiver; and
a second nozzle part formed in a cylindrical shape for allowing the coloring agent to pass therethrough, the second nozzle part being connected to the first nozzle part,
wherein the second nozzle parts is disposed nearer to the electric wire than the first nozzle part is disposed,
wherein the second nozzle part is made of polyetheretherketone.
